(19) United States
(12) Patent Application Publication
(10) Pub. No.: US 2015/0211649 A1
(43) Pub. Date: Jul. 30, 2015

(54) GAS OR LIQUID CONTROL SYSTEM AND METHOD OF OPERATING

(71) Applicant: Nabors Completion & Production Services Co., Houston, TX (US)

(72) Inventor: Toby KING, Yukon, OK (US)

(21) Appl. No.: 14/602,575

(22) Filed: Jan. 22, 2015

Related U.S. Application Data
(60) Provisional application No. 61/930,987, filed on Jan. 24, 2014.

(51) Int. Cl. F16K 17/20; E21B 41/00

(52) U.S. Cl. CPC F16K 17/20; E21B 41/0092

(57) ABSTRACT

A liquid or gas control system includes a manifold comprising an inlet port adapted to be coupled to a supply source, a control valve contained within the manifold and adapted to move between an open position and a closed position, a vent assembly coupled to the manifold including a purge valve in communication with the manifold and adapted to move between an open position and a closed position and allow a purge gas flow condition through the vent assembly and a relief valve in communication with the manifold and adapted to move between an open position and a closed position and allow a relief gas flow condition through the vent assembly.

### CROSS-REFERENCE TO RELATED APPLICATION(S)

This application claims priority under 35 U.S.C. §119(e) to U.S. patent application Ser. No. 61/930,987 entitled “GAS OR LIQUID CONTROL SYSTEM AND METHOD OF OPERATING,” by Toby King, filed Jan. 24, 2014, which is assigned to the current assignee hereof and incorporated herein by reference in its entirety.

### BACKGROUND

1. Field of the Disclosure

The following is directed to a gas or liquid control system for use in subterranean operations.

2. Description of the Related Art

Rigs used for wellbore operations, both land based and offshore, use a wide variety of tools, apparatuses, appliances, systems and devices that use electrical power. Typically power is supplied by one or more generators that run on diesel fuel or other hydrocarbon fuel. Such rigs, including, but not limited to, drilling rigs and production platforms, have for example, drawworks, pumps, motors mud pumps, drive system(s) (rotary, power swivel, top drive), pipe racking systems, hydraulic power units, and/or a variety of rig utilities (lights, A/C units, appliances), electronics, and control systems for these things. Typical conventional drilling rigs have one or more alternating current (AC) power generators which provide power to silicon controlled rectifier(s) which convert the AC power to DC power, e.g. for DC motors of various tools and systems, and for DC-powered top drives or prime movers.

In certain systems, rig generators have engines that run on natural gas (or other relatively clean fuels). Maximum fuel efficiency is achieved in generator engines (diesel and natural gas powered) at about 90% or higher load capacity. In addition to achieving greater fuel efficiency, some natural gas powered engines used in drilling and drilling related applications are operated at 70% or higher load capacity. This constraint is done to maintain high enough exhaust temperatures to assist catalytic converters in functioning properly.

The industry continues to demand improvements in the operation of generators and engines in drilling environments, including the delivery of source materials for operating such generators and engines.

### SUMMARY

According to a first aspect, a liquid or gas control system includes a manifold having an inlet port adapted to be coupled to a supply source, a control valve contained within the manifold and adapted to move between an open position and a closed position, and a vent assembly coupled to the manifold, wherein the vent assembly includes a purge valve in communication with the manifold and adapted to move between an open position and a closed position and allow a purge gas flow condition through the vent assembly, and a relief valve in communication with the manifold and adapted to move between an open position and a closed position and allow a relief gas flow condition through the vent assembly.

### BRIEF DESCRIPTION OF THE DRAWINGS

The present disclosure may be better understood, and its numerous features and advantages made apparent to those skilled in the art by referencing the accompanying drawings.

FIG. 1 includes a schematic of a drilling operation according to an embodiment.

FIG. 2 includes a schematic of a liquid or gas control system according to an embodiment.

### DETAILED DESCRIPTION

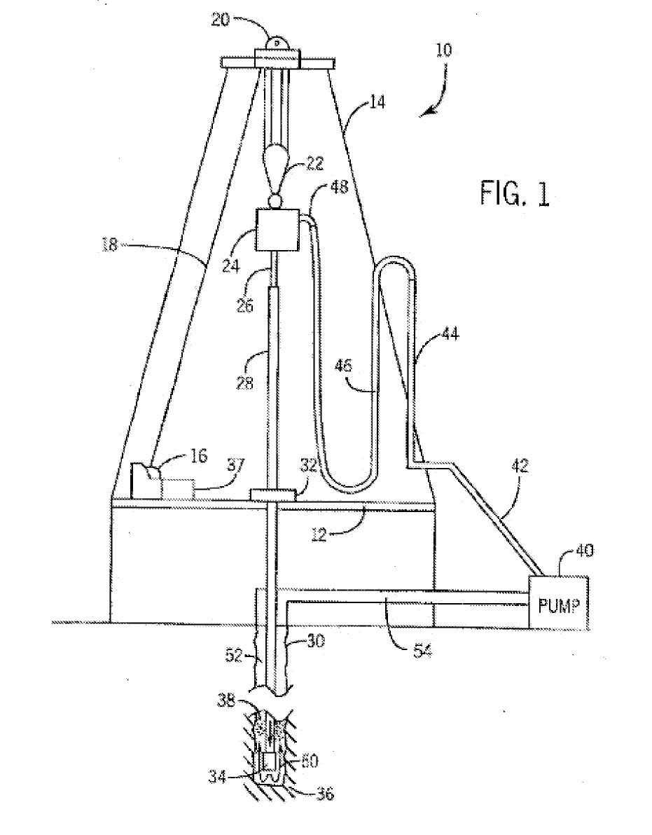

FIG. 1 includes a schematic representation of a drilling rig 10 in the process of drilling a well in accordance with embodiments disclosed herein is shown. The drilling rig 10 can include an elevated rig floor 12 and a derrick 14 extending above the floor 12. A drawworks 16 can supply a drilling line 18 to a crown block 20 and traveling block 22 in order to hoist various types of drilling equipment above the rig floor 12. The traveling block 22 may support a top drive 24, which can include a quill 26 used to turn tubulars or other drilling equipment. In the illustrated embodiment, the quill 26 can be coupled with a drill string 28, which is a total length of connected casing, drill pipe, or the like, extending into a well bore 30. One or more motors housed in the top drive 24 can facilitate the rotation of the drill string 28 at a desired speed as specified by a rig operator.

While a new tubular length is being attached to the drill string 28, the drill string 28 may be held stationary with respect to the rig floor 12 by a rotary table 32. In order to advance the well bore 30 to greater depths, the drill string 28 can include a bottom hole assembly (BHA), which includes a drill bit 34 for crushing or cutting rock away from a formation 36. Drilling mud may be circulated through the drilling rig 10 in order to remove cuttings 38 from the well bore 30. A mud pump 40 can pump drilling mud through a discharge line 42, stand pipe 44, rotary hose 46, and gooseneck 48 leading into the top drive 24. From here, the drilling mud can flow through the top drive 24 and down a channel through the drill string 28, exiting the drill string 28 through the drill bit 34 and through an annulus 52 formed between the well 30 and the drill string 28. A drilling mud return line 54 can convey the drilling mud and the cuttings 38 away from the annulus 52, returning the mud toward the pump 40. The mud, with the cuttings 38, may pass through a series of tanks (not shown) and other components used to separate the cuttings 38 from the drilling mud before the mud is circulated again by the pump 40.

Several factors may influence performance of the drilling rig 10, the performance being typically characterized by the speed at which the drill string 28 advances into the well bore 30, known as rate of penetration (ROP). For example, the drawworks 16 may contribute to a combined downward force applied to the drill bit 34 known as weight on bit (WOB). That is, the drawworks 16 may provide increasing lengths of drilling line 18 to the crown block 20 and the traveling block 22, increasing the WOB available for cutting forcefully into the formation 36. An autodriller 37 may be present on the drill rig 10 for controlling the drawworks 16 in response to the monitored performance of the drilling rig 10. That is, when the performance of the drilling rig 10 falls below a certain desired performance threshold, the autodriller 37 may utilize a processor and programming to automatically control the drawworks 16 to increase WOB in order to increase the performance.

It should be noted that FIG. 1 is merely a representative embodiment, and certain illustrated features may be different in other embodiments. For example, the drilling rig 10 may use a kelly drive system in conjunction with the rotary table 32 to turn the drill string 28 at a desired rotational speed, instead of the top drive 24. In addition, the drill string 28 may remain generally stationary while a down-hole motor located near the BHA rotates the drill bit 34.

It will be appreciated that all of these components require one or more motor systems that will require an energy source for continued operation. Various energy sources and materials may be utilized, however, subterranean operations, such as the one generally illustrated in FIG. 1 typically require some liquid or gas energy source, including for example, natural gas. These energy sources and materials can be highly volatile and require safe handling and transportation around the drilling rig 10 via a liquid or gas control system. Such control systems may be portable, such that they are adapted to be moved on a vehicle (e.g., a flatbed truck). Moreover, such control systems must be carefully crafted, since, unlike other more conventional liquid or gas conveyance systems in other environments, drill rigs are dangerous environments and expensive to operate. The cost of failure of one of the components can mean the loss of human life, millions of dollars per day in productivity, and severe damage to the environment.

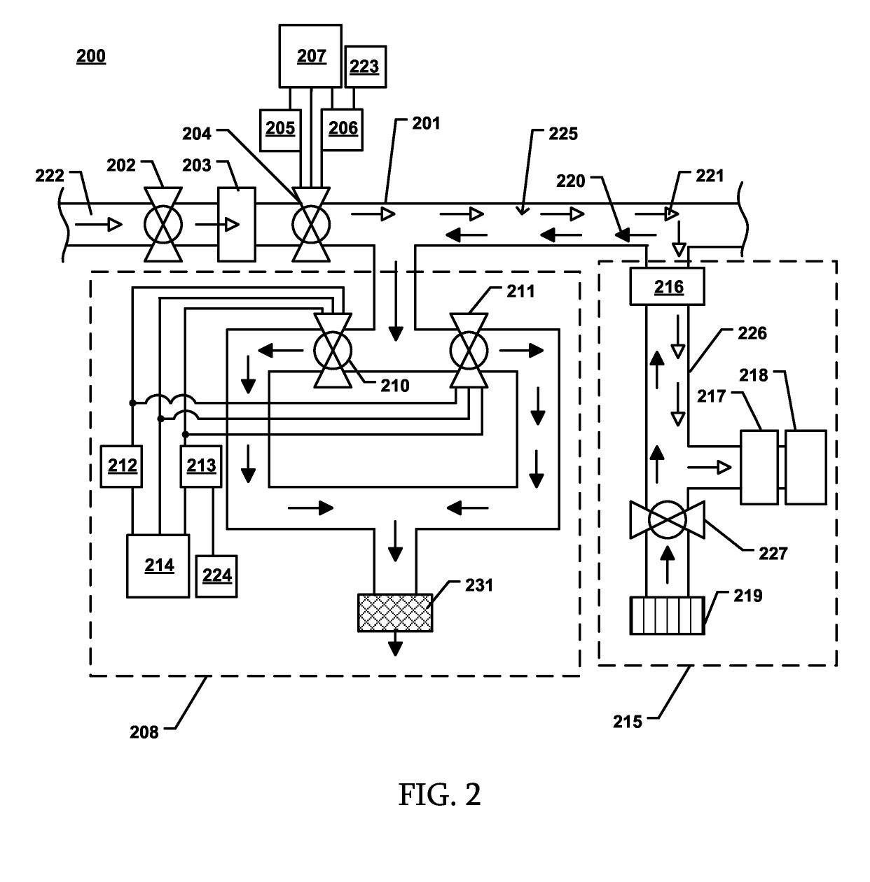

FIG. 2 includes a schematic of a liquid or gas control system according to an embodiment. As illustrated, the liquid or gas control system 200 can include a manifold 201 that can include an inlet port 203 adapted to be coupled to a supply source 222. The supply source may be configured to deliver a liquid or gas energy source, including for example, but not limited to natural gas and the manifold 201 can be adapted to transport natural gas as a fuel source to one or more devices (e.g., an engine) that are used for a subterranean operation.

The supply source may include a valve 202 adjacent the inlet port 203 and configured to control the flow of the source material from the supply source 222 to the manifold 201. Moreover, the valve 202 can facilitate coupling and decoupling of the manifold 200 of the liquid or gas control system 200 without unregulated expulsion of the source material. That is, prior to decoupling of the manifold 201 from the supply source 222, the valve 202 may be moved from an open position to a closed position to reduce or eliminate source material from escaping the supply source containment.

As illustrated, the manifold 201 can include an inlet port 203 for coupling of the manifold 201 to the supply source 222. The inlet port 203 can be coupled to the supply source 222 using a coupling. According to one embodiment, the inlet port 203 can be coupled to the supply source 222 using a fail-close coupling, which can close automatically if the coupling between the supply source 222 and the manifold 201 is partially or completely disengaged. The fail-close coupling can utilize any suitable actuation mechanism, including electrical actuation (e.g., an electrical switch), mechanical actuation, and the like. According to one particular embodiment, the fail-close coupling of the inlet port 203 can include a rotate-and-lock connection, wherein the ends of the manifold 201 and the supply source 222 are coupled and rotated relative to each other to securely lock the components together. In the instance that the coupling is disengaged, such as by counter-rotation of the components relative to each other, the coupling closes and limits uncontrolled discharge of the source material. In one particular embodiment, the coupling can be a TODO® coupling. In this manner, one or more ports of the manifold 201 can be decoupled without significant loss in pressure within the manifold 201.

The manifold 201 can further include a control valve 204 coupled to the inlet port 203, contained within the manifold 201, and adapted to move between an open position and a closed position. The control valve 204 can be configured to control the flow of liquid or gas supply material from the supply source 222 to the manifold 201. For example, in a closed position, the control valve 204 can limit the passage of any source material from the supply source 222 to the manifold 201. However, in an open position or partially open position, the supply material can flow from the supply source 222 into the manifold 201. The position of the control valve 204 may be controlled to control the flow and amount of source material flowing from the supply source 222 to the manifold 201.

According to one embodiment, the control valve 204 can be electrically actuated between the open position and the closed position. The control valve 204 may be operated directly by a rig operator or remotely by an off-site operator. In more particular instances, the control valve 204 can include a mechanical fail-safe actuator adapted to move the valve between the open position and the closed position. In particular instances, the mechanical fail-safe actuator may be utilized if the electrical actuator fails, is working improperly, or utilized by an operator. The mechanical actuation maybe particular suitable in conditions of failure of the electrical actuator and the control valve 204 must be moved from an open position to a closed position to halt flow of a supply material through the control valve 204 and/or manifold 201.

In other instances, the control valve 204 may include a mechanical fail-close actuator adapted to move the valve between the open position and the closed position. A fail-close actuator may be an automatically and mechanically actuated mechanism that moves the control valve 204 from an open position to a closed position upon failure of the electrical actuator to operate. A fail-close mechanism may not need to be selectively operated by a user but may be an automated mechanism adapted to close the control valve 204 upon a condition precedent (e.g., a signal from a controller indicating that the electrical actuator has failed or an alarm condition).

In certain instances, the control valve 204 can be coupled to a controller 207 adapted to control movement of the control valve 204 between an open position and a closed position. For example, the controller 207 may be adapted to control the mechanical actuator and electrical actuator of the control valve 204. The controller may be configured to be operated by an on-site operator or remotely by an off-site operator.

As further illustrated, the control valve 204 can be coupled to a flow meter 205 adapted to measure the flow of source material through the control valve 204. The flow meter 205 can be coupled to the controller 207 and adapted to control the position of the control valve 204 (i.e., open position, closed, position, or partially open) based on the measured flow of source material through the control valve 204. For example, the flow meter 205 can be adapted to send a flow meter signal to the controller 207 and the controller 207 can be adapted to control a position of the control valve 204 based upon the flow meter signal. In this manner, the control valve 204 may be utilized to monitor and control the amount of source material entering the manifold 201, and in particular, depending upon the design of the control valve 204, the combination of the flow meter 205, controller 207 and control valve 204 may be used to adjust the flow rate of source material entering the manifold 201. It will be appreciated that other flow meters can be positioned throughout various positions within the manifold 201 and coupled to the controller 207 such that the position of the control valve 204 may be modified by the controller 207 based on the measured flow of material at other locations within the manifold 201.

According to another embodiment, the control valve 204 can be coupled to a gas analyzer 206, which can be coupled to the controller 207. The gas analyzer 206 can be adapted to measure the content of certain gas species within the control valve 204. Moreover, the gas analyzer 206 can be adapted to send a gas analysis signal to the controller 207 and control a position of the control valve 204 (i.e., open position, closed, position, or partially open) based upon the gas analysis signal. In at least one aspect, the control valve 204 may be utilized to monitor and control the amount of certain gas species entering the manifold 201, and in particular, depending upon the design of the control valve 204, the combination of the gas analyzer 206, controller 207, and control valve 204 may be used to adjust the flow rate of source material entering the manifold 201 based upon the presence or absence of certain gas species. It will be appreciated that other gas analyzers can be positioned throughout various positions within the manifold 201 and coupled to the controller 207 such that the position of the control valve 204 may be modified by the controller 207 based on the measured content of certain gas species at other locations within the manifold 201.

Moreover, the gas analyzer 206 may be coupled to a storage device 223, which may be adapted to store the gas analysis data, such that the system may be capable of monitoring and logging historical data on gas species, which may be useful to certain operators and customers. While the storage device 223 is illustrated as being directly coupled to the gas analyzer 206, it will be appreciated that in certain other instances, the storage device 223 may be integrated with the controller 207 or the gas analyzer 206. In other instances, the storage device 223 may be remote, and the gas analysis data may be sent wirelessly to a remote storage device.

According to another embodiment, the gas or liquid control system 200 can include a vent assembly 208 coupled to the manifold 201 and include a purge valve 210 and a relief valve 211. The purge valve 210 can be in communication with the manifold 201 and adapted to move between an open position and a closed position. Moreover, the purge valve 210 can be adapted to facilitate a purge gas flow condition through the vent assembly 208 and at least a portion of the manifold 201. The vent assembly 208 can be adapted to control the pressure within the manifold 201 by providing a secondary avenue for material to be expelled from the manifold 201 such as through the purge outlet port 231. More particularly, the vent assembly 208 can be configured to facilitate purging of one or more liquids or gases from at least a portion of the manifold 201

The purge valve 210 may include any of the features of other valves of the embodiments herein. For example, the purge valve 210 can be electrically actuated between the open position and the closed position. The purge valve 210 may be operated directly by a rig operator or remotely by an off-site operator. In more particular instances, the purge valve 210 can include a mechanical fail-safe actuator adapted to move the valve between the open position and the closed position. In particular instances, the mechanical fail-safe actuator may be utilized if the electrical actuator fails, is working improperly, or utilized by an operator. The mechanical actuation maybe particular suitable in conditions of failure of the electrical actuator and the purge valve 210 must be moved from an open position to a closed position to halt flow of a material through the vent assembly 208 from the manifold 201.

In other instances, the purge valve 210 may include a mechanical fail-close actuator adapted to move the valve between the open position and the closed position. A fail-close actuator may be an automatically and mechanically actuated mechanism that moves the purge valve 210 from an open position to a closed position upon failure of the electrical actuator to operate. A fail-close mechanism may not need to be selectively operated by a user but may be an automated mechanism adapted to close the purge valve 210 upon a condition precedent (e.g., a signal from a controller indicating that the electrical actuator has failed or an alarm condition).

In certain instances, the purge valve 210 can be coupled to a controller 214 adapted to control movement of the purge valve 210 between an open position and a closed position. For example, the controller 214 may be adapted to control the mechanical actuator and electrical actuator of the purge valve 210. The controller may be configured to be operated by an on-site operator or remotely by an off-site operator.

As further illustrated, the purge valve 210 can be coupled to a flow meter 212 adapted to measure the flow of material (e.g., a purge gas and/or source material) through the purge valve 210. The flow meter 212 can be coupled to the controller 214 and adapted to control the position of the purge valve 210 (i.e., open position, closed, position, or partially open) based on the measured flow of material through the purge valve 210. For example, the flow meter 212 can be adapted to send a flow meter signal to the controller 214, and the controller 214 can be adapted to control a position of the purge valve 210 based upon the flow meter signal. In this manner, the purge valve 210 may be utilized to monitor and control the amount of material entering the vent assembly 208, and in particular, depending upon the design of the purge valve 210, the combination of the flow meter 212, controller 214 and purge valve 210 may be used to adjust the flow rate of material entering the vent assembly. It will be appreciated that other flow meters can be placed in various positions within the manifold 201 and/or vent assembly 208 and coupled to the controller 214 such that the position of the purge valve 210 may be modified by the controller 214 based on the measured flow of material at other locations within the manifold 201 and/or vent assembly 208.

According to another embodiment, the purge valve 210 can be coupled to a gas analyzer 213, which can be coupled to the controller 214. The gas analyzer 213 can be adapted to measure the content of certain gas species within the purge valve 210. Moreover, the gas analyzer 213 can be adapted to send a gas analysis signal to the controller 214 and control a position of the purge valve 210 (i.e., open position, closed, position, or partially open) based upon the gas analysis signal. In at least one aspect, the purge valve 210 may be utilized to monitor and control the amount of certain gas species entering the manifold 201 and/or vent assembly 208, and in particular, depending upon the design of the purge valve 210, the combination of the gas analyzer 213, controller 214, and purge valve 210 may be used to adjust the flow rate of material entering the manifold 201 and/or vent assembly 208 based upon the presence or absence of certain gas species. It will be appreciated that other gas analyzers can be positioned throughout various positions within the manifold 201 and/or vent assembly 208 and coupled to the controller 214 such that the position of the purge valve 210 may be modified by the controller 214 based on the measured content of certain gas species at other locations within the manifold 201 and/or vent assembly 208.

Moreover, the gas analyzer 213 may be coupled to a storage device 224, which may be adapted to store the gas analysis data, such that the system may be capable of monitoring and logging historical data on gas species within the vent assembly 208 and/or manifold 201, which may be useful to certain operators and customers. While the storage device 224 is illustrated as being directly coupled to the gas analyzer 213, it will be appreciated that in certain other instances, the storage device 224 may be integrated within the controller 214 or the gas analyzer 213. In other instances, the storage device 224 may be remote, and the gas analysis data may be sent wirelessly to a remote storage device.

Moreover, while the vent assembly 208 is illustrated as having a controller 214, flow meter 212, gas analyzer 213, and storage device 224 that is distinct from the controller 207, flow meter 205, gas analyzer 206, and storage device 223 coupled to the control valve 204, it will be appreciated that in other systems, all components may be coupled to the same controller, flow meter, gas analyzer, and storage device. Additionally, in certain designs, more than one controller may be utilized, but the controllers may be coupled to each other and adapted to communicate with each other, exchange data with each other, and control the operation of one or more components to which they are directly or indirectly coupled to.

According to another embodiment, the relief valve 211 can be in communication with the manifold 201 and adapted to move between an open position and a closed position and allow a relief gas flow condition through the vent assembly 208. The relief valve 211 may include any of the features of other valves of the embodiments herein. For example, the relief valve 211 can be electrically actuated between the open position and the closed position. The relief valve 211 may be operated directly by a rig operator or remotely by an off-site operator. In more particular instances, the relief valve 211 can include a mechanical fail-safe actuator adapted to move the valve between the open position and the closed position. In particular instances, the mechanical fail-safe actuator may be utilized if the electrical actuator fails, is working improperly, or utilized by an operator. The mechanical actuation maybe particular suitable in conditions of failure of the electrical actuator and the relief valve 211 must be moved from an open position to a closed position to halt flow of a material through the vent assembly 208 from the manifold 201.

In other instances, the relief valve 211 may include a mechanical fail-close actuator adapted to move the valve between the open position and the closed position. A fail-close actuator may be an automatically and mechanically actuated mechanism that moves the relief valve 211 from an open position to a closed position upon failure of the electrical actuator to operate. A fail-close mechanism may not need to be selectively operated by a user but may be an automated mechanism adapted to close the relief valve 211 upon a condition precedent (e.g., a signal from a controller indicating that the electrical actuator has failed or an alarm condition).

In certain instances, the relief valve 211 can be coupled to the controller 214 adapted to control movement of the relief valve 211 between an open position and a closed position. For example, the controller 214 may be adapted to control the mechanical actuator and electrical actuator of the relief valve 211. The controller may be configured to be operated by an on-site operator or remotely by an off-site operator.

As further illustrated, the relief valve 211 can be coupled to the flow meter 212 adapted to measure the flow of material (e.g., a purge gas and/or source material) through the purge valve 210 and/or the relief valve 211. The flow meter 212 can be coupled to the controller 214 and adapted to control the position of the relief valve 211 (i.e., open position, closed, position, or partially open) based on the measured flow of material through the relief valve 211. For example, the flow meter 212 can be adapted to send a flow meter signal to the controller 214, and the controller 214 can be adapted to control a position of the relief valve 211 based upon the flow meter signal. In this manner, the relief valve 211 may be utilized to assist in the movement of a material through the vent assembly 208, and in particular, depending upon the design of the relief valve 211, the combination of the flow meter 212, controller 214 and relief valve 211 may be used to adjust the flow rate of material through the vent assembly. It will be appreciated that other flow meters can be placed in various positions within the manifold 201 and/or vent assembly 208 and coupled to the controller 214 such that the operation of the relief valve 211 may be modified by the controller 214 based on the measured flow of material at other locations within the manifold 201 and/or vent assembly 208.

According to another embodiment, the relief valve 211 can be coupled to the gas analyzer 213, which can be coupled to the controller 214. The gas analyzer 213 can be adapted to measure the content of certain gas species within the relief valve 211. Moreover, the gas analyzer 213 can be adapted to send a gas analysis signal to the controller 214 and control a position of the relief valve 211 (i.e., open position, closed, position, or partially open) based upon the gas analysis signal. In at least one aspect, the relief valve 211 may be utilized to monitor and control the amount of certain gas species entering the manifold 201 and/or vent assembly 208, and in particular, depending upon the design of the relief valve 211, the combination of the gas analyzer 213, controller 214, and relief valve 211 may be used to adjust the flow rate of material through the manifold 201 and/or vent assembly 208 based upon the presence or absence of certain gas species. It will be appreciated that other gas analyzers can be positioned throughout various positions within the manifold 201 and/or vent assembly 208 and coupled to the controller 214 such that the position of the relief valve 211 may be modified by the controller 214 based on the measured content of certain gas species at other locations within the manifold 201 and/or vent assembly 208. Moreover, while the relief valve 211 and purge valve are illustrated as coupled to the same controller 214, flow meter 212, gas analyzer 213, and storage device 224, in other embodiments, the relief valve 211 and purge valve 210 may be coupled to discrete controllers, flow meters, and gas analyzers.

The liquid or gas control system 200 can further include a trunk line 225 extending from the inlet port 203 to a first outlet port 216. As illustrated, the vent assembly 208 can be connected to the trunk line 225. The trunk line can be a primary pipe configured to convey a majority of the source material in a forward flow condition.

As further illustrated, the liquid or gas control system 200 can include a first outlet assembly 215, which can include the first outlet port 216 coupled to the manifold 201 at the trunk line. The first outlet assembly 215 can further include an outlet mainline 226 coupling the first outlet port 216 with a purge gas system 219 and a purge gas system valve 227 disposed between the first outlet port 216 and the purge gas system 219. As further illustrated, the first outlet assembly 215 can include at least one fuel intake 217 coupled to the outlet mainline 226 and in communication with the trunk line 225 of the manifold 201 via the first outlet port 216. As further illustrated, the first outlet assembly 215 may include an optional device 218, which can be in the form of a motor or other device operating on the source material delivered through the manifold 201. As will be appreciated, the device 218 is in communication with the supply source 222 via the trunk line 225 of the manifold 201 and further in communication with the first outlet port 216 coupled to the mainline 226 and fuel intake 217 of the first outlet assembly. It will be appreciated that other outlet assemblies can be connected in parallel from the trunk line 225 of the manifold 201.

The first outlet port 216 can include a coupling joining the first outlet assembly 215 to the trunk line 225 of the manifold. The coupling of the first outlet port 216 can include any of the features of the couplings according to embodiments herein. Notably, the first outlet port 216 can be coupled to the trunk line 225 using a fail-close coupling, which can close automatically if the coupling between the trunk line 225 and the first outlet port 216 is partially or completely disengaged. The fail-close coupling can utilize any suitable actuation mechanism, including electrical actuation (e.g., an electrical switch), mechanical actuation, and the like. According to one particular embodiment, the fail-close coupling of the first outlet port 216 can include a rotate-and-lock connection, wherein the ends of the trunk line 225 and the outlet mainline 226 are coupled and rotated relative to each other to securely lock the components together. In the instance that the coupling is disengaged, such as by counter-rotation of the components relative to each other, the coupling closes and limits uncontrolled discharge of the source material and/or purge gas from the system. In one particular embodiment, the coupling can be a TODO® coupling. In this manner, even during a decoupling, the pressure within the system or portions of the system can be maintained.

The fuel intake 217 can include a coupling having any of the features of the embodiments herein. For example, the fuel intake 217 can be coupled to the outlet mainline 226 using a fail-close coupling, which can close automatically if the coupling between the outlet mainline 226 and the fuel intake 217 is partially or completely disengaged. The fail-close coupling can utilize any suitable actuation mechanism, including electrical actuation (e.g., an electrical switch), mechanical actuation, and the like. According to one particular embodiment, the fail-close coupling of the fuel intake 217 can include a rotate-and-lock connection, wherein the ends of the outlet mainline 226 and an end of the line from the device 218 are coupled and rotated relative to each other to securely lock the components together. In the instance that the coupling is disengaged, such as by counter-rotation of the components relative to each other, the coupling closes and limits uncontrolled discharge of the source material and/or purge gas from the system. In one particular embodiment, the coupling can be a TODO® coupling. In this manner, even during a decoupling, the pressure within the system or portions of the system can be maintained.

According to one embodiment, the manifold 201 can be adapted to operate under different conditions, including for example, a forward flow condition, a purge gas flow condition, and a relief flow condition. Each of the conditions can define different flow paths of one or more materials through portions of the manifold 201. The forward flow condition is adapted to provide the source material to the device 218 through a portion of the manifold 201. For example, in a forward flow condition, a source material from the supply source 222 flows through the trunk line 225 of the manifold in the direction indicated by the arrows 221. The source material flows through an open control valve 204 along the trunk line 225, to the first outlet port 216, into the outlet mainline 226 of the outlet assembly 215, and into the device 218 through the fuel intake 217. In a forward flow condition, the control valve 204 can be in a partially open position or fully open position, the purge valve 210 can be in a closed position, the relief valve 211 can be in a closed position, and the purge system valve 227 can be in a closed position.

As illustrated, the purge gas system 219 can be in communication with the manifold 201 and adapted to provide a purge gas to the manifold 201 in the purge gas flow condition. In particular instances, the purge gas system 219 can be coupled to the first outlet port 216 and trunk line 225 of the manifold 201. Moreover, the purge gas system 219 can be in communication with the fuel intake 217 and configured to purge material from the fuel intake 217 in a purge gas flow condition.

During a purge gas flow condition, a purge gas can be flowed through a portion of the manifold 201. The purge gas can be an inert gas, a noble gas, and a combination thereof. In particular instances, the purge gas can include nitrogen.

According to one embodiment, in the purge gas flow condition, the manifold 201 is adapted for flow of gas or liquid through the manifold 201 in a direction from the first outlet port 216 to the vent assembly 208, and more particularly, to a purge outlet port 231 in the vent assembly 208. The purge gas flow condition can be suitable to facilitate removal of a source material from at least a portion of the manifold 201 and at least a portion of the first outlet assembly 215. In other instances, the purge gas flow condition can be suitable for mixing of one or more gases within the manifold, including for example, a source gas and a purge gas.

As provided in FIG. 2, the purge gas system 219 comprises a purge gas system valve 227 that is adapted to be moved between an open position and a closed position. In the purge gas flow condition, the purge gas system valve 227 can be in an open position and the purge gas can flow from the purge gas system 219 through at least a portion of the outlet mainline 226 in the direction indicated by the arrows 220. Moreover, during a purge gas flow condition, the purge gas flows from the outlet mainline 226, to the first outlet port 216, to the trunk line 225 and to the purge valve 210 of the vent assembly 208. Notably, in the purge gas flow condition, the control valve 204 can be in the closed position, the purge valve 210 can be in the open position, the purge gas system valve 219 can be in the open position, and the relief valve 211 may be in a closed position. Moreover, during a purge gas flow condition, at least a portion of the purge gas flows through a portion of a fuel intake 217 and may facilitate removal of some source gas material from the fuel intake 217 and a portion of the trunk line 225.

In a relief gas flow condition, the manifold 201 can be adapted for flow of gas or liquid through the manifold 201 in a direction from the first outlet port 216 to a purge outlet port 231 in the vent assembly 208. More particularly, in the relief gas flow condition, a purge gas may flow from the purge gas system 219, to the outlet mainline 226, to the first outlet port 216, to the trunk line 225 and to the relief valve 211 of the vent assembly 208. In the relief gas flow condition, the control valve 204 can be in the closed position or the open position, the purge valve 210 can be in the open position or in the closed position, the purge gas system valve 219 can be in the open position or closed position, and the relief valve 211 is in an open position. Notably, the relief gas flow condition is primarily indicated by the open position of the relief valve 211. The relief gas flow condition may be utilized in combination with a forward flow condition, in instances where some pressure must be reduced in the manifold 201 other condition wherein an operator wishes to remove material from the manifold 201. In other instances, the relief gas flow condition may be used in conjunction with a purge gas flow condition, wherein a purge gas is flowing in the direction 220 within the manifold 201 and the relief valve 211 may be in an open position, the purge valve 210 may be in an open position and the control valve 204 can be in a closed position.

As noted herein, in certain operations, the manifold 201 may be adapted for mixing of gases and/or fluids within the manifold 201. For example, a first gas can be provided from the inlet port 203 and a second gas can be provided from the first outlet port 216, and the gases can be mixed in the manifold 201. Such a process may prove suitable if there are one or more downstream devices, such as an engine, coupled to the trunk line that may utilize a mixture of one or more gases and such a mixture can be made prior to delivery to the device.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Item 1. A liquid or gas control system comprising:

a manifold comprising an inlet port adapted to be coupled to a supply source;
a control valve contained within the manifold and adapted to move between an open position and a closed position;
a vent assembly coupled to the manifold, wherein the vent assembly comprises:
a purge valve in communication with the manifold and adapted to move between an open position and a closed position and allow a purge gas flow condition through the vent assembly; and
a relief valve in communication with the manifold and adapted to move between an open position and a closed position and allow a relief gas flow condition through the vent assembly.

Item 2. The liquid or gas control system of item 1, wherein the inlet port is coupled to the supply source using a fail-close coupling.

Item 3. The liquid or gas control system of item 1, wherein the fail-close coupling comprises a rotate-and-lock connection.

Item 4. The liquid or gas control system of item 1, wherein the manifold further comprises a first outlet port coupled to at least one fuel intake.

Item 5. The liquid or gas control system of item 4, wherein the manifold comprises a trunk line, and at least one fuel intake is couple to the trunk line.

Item 6. The liquid or gas control system of item 5, wherein the at least one fuel intake is coupled to the first outlet port of the manifold.

Item 7. The liquid or gas control system of item 4, wherein the outlet port is coupled to the at least one fuel intake with a fail-close coupling.

Item 8. The liquid or gas control system of item 7, wherein the fail-close coupling comprises a rotate-and-lock connection.

Item 9. The liquid or gas control system of item 1, wherein the manifold is adapted for flow of gas or liquid through the manifold in a direction from the inlet port to the first outlet port in a forward flow condition.

Item 10. The liquid or gas control system of item 9, wherein in the forward flow condition the control valve is in the open position, the purge valve is in the closed position, and the relief valve is in the closed position.

Item 11. The liquid or gas control system of item 1, wherein the manifold is adapted for flow of gas or liquid through the manifold in a direction from the first outlet port to a purge outlet port in a purge gas flow condition.

Item 12. The liquid or gas control system of item 12, wherein in the purge gas flow condition, the control valve is in the closed position and the purge valve is the open position.

Item 13. The liquid or gas control system of item 12, wherein in the purge gas flow condition the relief valve is in the closed position.

Item 14. The liquid or gas control system of item 1, further comprising a purge gas system in communication with the manifold and adapted to provide a purge gas to the manifold in the purge gas flow condition.

Item 15. The liquid or gas control system of item 14, wherein the purge gas system is coupled to a first outlet port of the manifold.

Item 16. The liquid or gas control system of item 14, wherein the purge gas system is coupled to a trunk line of the manifold.

Item 17. The liquid or gas control system of item 14, wherein the purge gas system is in communication with at least one fuel intake.

Item 18. The liquid or gas control system of item 14, wherein the purge gas system comprises a purge gas system valve adapted to be moved between an open position and a closed position, wherein in the purge gas flow condition, the purge gas system valve is open and the purge gas flows from the purge gas system through at least a portion of the trunk line to the purge valve of the vent assembly.

Item 19. The liquid or gas control system of item 18, wherein in the purge gas flow condition at least a portion of the purge gas flows through a portion of a fuel intake line.

Item 20. The liquid or gas control system of item 14, wherein the purge gas comprises an inert gas.

Item 21. The liquid or gas control system of item 20, wherein the purge gas comprises a noble gas.

Item 22. The liquid or gas control system of item 20, wherein the purge gas comprises nitrogen.

Item 23. The liquid or gas control system of item 1, wherein the manifold is adapted for flow of gas or liquid through the manifold in a direction from the first outlet port to a purge outlet port in the relief gas flow condition.

Item 24. The liquid or gas control system of item 23, wherein in the relief gas flow condition the control valve is in the closed position, the purge valve is the open position and the relief valve is in the open position.

Item 25. The liquid or gas control system of item 1, wherein the control valve is adapted to be electrically actuated between the open position and the closed position.

Item 26. The liquid or gas control system of item 1, wherein the control valve comprises a mechanical fail-safe actuator adapted to move the valve between the open position and the closed position.

Item 27. The liquid or gas control system of item 1, wherein the control valve comprises a mechanical fail-close actuator adapted to move the valve between the open position and the closed position.

Item 28. The liquid or gas control system of item 1, wherein the control valve is coupled to a controller adapted to control movement of the control valve between an open position and a closed position.

Item 29. The liquid or gas control system of item 28, wherein controller is coupled to a flow meter, and wherein the flow meter is adapted to send a flow meter signal to the controller and the controller is adapted to control a position of the control valve based upon the flow meter signal.

Item 30. The liquid or gas control system of item 28, wherein controller is coupled to a gas analyzer, and wherein the gas analyzer is adapted to send a gas analysis signal to the controller and the controller is adapted to control a position of the control valve based upon the gas analysis signal.

Item 31. The liquid or gas control system of item 30, wherein the controller is configured to send the gas analysis signal to a storage device.

Item 32. The liquid or gas control system of item 1, wherein the purge valve is adapted to be electrically actuated between the open position and the closed position.

Item 33. The liquid or gas control system of item 1, wherein the purge valve comprises a mechanical fail-safe actuator adapted to move the valve between the open position and the closed position.

Item 34. The liquid or gas control system of item 1, wherein the purge valve comprises a mechanical fail-close actuator adapted to move the valve between the open position and the closed position.

Item 35. The liquid or gas control system of item 1, wherein the purge valve is coupled to a controller adapted to control movement of the purge valve between an open position and a closed position.

Item 36. The liquid or gas control system of item 35, wherein the purge valve and the control valve are coupled to a same controller.

Item 37. The liquid or gas control system of item 35, wherein the controller is coupled to a flow meter, and wherein the flow meter is adapted to send a flow meter signal to the controller and the controller is adapted to control a position of the purge valve based upon the flow meter signal.

Item 38. The liquid or gas control system of item 35, wherein the controller is coupled to a gas analyzer, and wherein the gas analyzer is adapted to send a gas analysis signal to the controller and the controller is adapted to control a position of the purge valve based upon the gas analysis signal.

Item 39. The liquid or gas control system of item 38, wherein the controller is configured to send the gas analysis signal to a storage device.

Item 40. The liquid or gas control system of item 1, wherein the relief valve is adapted to be electrically actuated between the open position and the closed position.

Item 41. The liquid or gas control system of item 1, wherein the relief valve comprises a mechanical fail-safe actuator adapted to move the relief valve between the open position and the closed position.

Item 42. The liquid or gas control system of item 1, wherein the relief valve comprises a mechanical fail-close actuator adapted to move the relief valve between the open position and the closed position.

Item 43. The liquid or gas control system of item 1, wherein the relief valve is coupled to a controller adapted to control movement of the relief valve between an open position and a closed position.

Item 44. The liquid or gas control system of item 43, wherein the relief valve, purge valve, and the control valve are coupled to a same controller.

Item 45. The liquid or gas control system of item 43, wherein the controller is coupled to a flow meter, and wherein the flow meter is adapted to send a flow meter signal to the controller and the controller is adapted to control a position of the relief valve based upon the flow meter signal.

Item 46. The liquid or gas control system of item 1, wherein the vent assembly is adapted to control the pressure within the manifold.

Item 47. The liquid or gas control system of item 1, wherein the vent assembly is configured to purge a gas or liquid from the manifold.

Item 48. The liquid or gas control system of item 1, wherein the manifold is adapted to transport natural gas as a fuel source for a subterranean operation.

Item 49. The liquid or gas control system of item 1, wherein at least one of the inlet port or an outlet port of the manifold can be decoupled without significant loss in pressure within the manifold.

Item 50. The liquid or gas control system of item 1, wherein the manifold is adapted for mixing of gas within the manifold, wherein a first gas is provided from the inlet port and a second gas is provided from an outlet port.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description of the Drawings, with each claim standing on its own as defining separately claimed subject matter.

What is claimed is:

1. A liquid or gas control system comprising:
a manifold comprising an inlet port adapted to be coupled to a supply source;
a control valve contained within the manifold and adapted to move between an open position and a closed position;
a vent assembly coupled to the manifold, wherein the vent assembly comprises:
a purge valve in communication with the manifold and adapted to move between an open position and a closed position and allow a purge gas flow condition through the vent assembly; and
a relief valve in communication with the manifold and adapted to move between an open position and a closed position and allow a relief gas flow condition through the vent assembly.

2. The liquid or gas control system of claim 1, wherein the inlet port is coupled to the supply source using a fail-close coupling, comprises a rotate-and-lock connection.

3. The liquid or gas control system of claim 1, wherein the manifold further comprises a first outlet port coupled to at least one fuel intake.

4. The liquid or gas control system of claim 3, wherein the manifold comprises a trunk line, and at least one fuel intake is couple to the trunk line, and wherein the at least one fuel intake is coupled to the first outlet port of the manifold, and wherein the first outlet port is coupled to the at least one fuel intake with a fail-close coupling.

5. The liquid or gas control system of claim 4, wherein the fail-close coupling comprises a rotate-and-lock connection.

6. The liquid or gas control system of claim 1, wherein the manifold is adapted for flow of gas or liquid through the manifold in a direction from the inlet port to the first outlet port in a forward flow condition.

7. The liquid or gas control system of claim 6, wherein in the forward flow condition the control valve is in the open position, the purge valve is in the closed position, and the relief valve is in the closed position.

8. The liquid or gas control system of claim 1, wherein the manifold is adapted for flow of gas or liquid through the manifold in a direction from the first outlet port to a purge outlet port in a purge gas flow condition.

9. The liquid or gas control system of claim 9, wherein in the purge gas flow condition, the control valve is in the closed position, the purge valve is the open position, and the relief valve is in the closed position.

10. The liquid or gas control system of claim 1, further comprising a purge gas system in communication with the manifold and adapted to provide a purge gas to the manifold in the purge gas flow condition, wherein the purge gas system is coupled to at least one of a first outlet port of the manifold, a trunk line of the manifold, or at least one fuel intake.

11. The liquid or gas control system of claim 10, wherein the purge gas system comprises a purge gas system valve adapted to be moved between an open position and a closed position, wherein in the purge gas flow condition, the purge gas system valve is open and the purge gas flows from the purge gas system through at least a portion of the trunk line to the purge valve of the vent assembly.

12. The liquid or gas control system of claim 1, wherein the manifold is adapted for flow of gas or liquid through the manifold in a direction from the first outlet port to a purge outlet port in the relief gas flow condition, wherein in the relief gas flow condition the control valve is in the closed position, the purge valve is the open position and the relief valve is in the open position.

13. The liquid or gas control system of claim 1, wherein the control valve comprises a mechanical fail-close actuator adapted to move the valve between the open position and the closed position.

14. The liquid or gas control system of claim 1, wherein the control valve is coupled to a controller adapted to control movement of the control valve between an open position and a closed position, and further wherein controller is coupled to a flow meter, and wherein the flow meter is adapted to send a flow meter signal to the controller and the controller is adapted to control a position of the control valve based upon the flow meter signal.

15. The liquid or gas control system of claim 14, wherein controller is coupled to a gas analyzer, and wherein the gas analyzer is adapted to send a gas analysis signal to the controller and the controller is adapted to control a position of the control valve based upon the gas analysis signal.

16. The liquid or gas control system of claim 1, wherein the purge valve comprises a mechanical fail-close actuator adapted to move the valve between the open position and the closed position.

17. The liquid or gas control system of claim 1, wherein the purge valve is coupled to a controller adapted to control movement of the purge valve between an open position and a closed position, and further wherein the controller is coupled to a flow meter, and wherein the flow meter is adapted to send a flow meter signal to the controller and the controller is adapted to control a position of the purge valve based upon the flow meter signal.

18. The liquid or gas control system of claim 17, wherein the controller is coupled to a gas analyzer, and wherein the gas analyzer is adapted to send a gas analysis signal to the controller and the controller is adapted to control a position of the purge valve based upon the gas analysis signal.

19. The liquid or gas control system of claim 1, wherein the relief valve is coupled to a controller adapted to control movement of the relief valve between an open position and a closed position, and wherein the controller is coupled to a flow meter, and wherein the flow meter is adapted to send a flow meter signal to the controller and the controller is adapted to control a position of the relief valve based upon the flow meter signal.

20. The liquid or gas control system of claim 1, wherein at least one of the inlet port or an outlet port of the manifold can be decoupled without significant loss in pressure within the manifold.
